(19) United States
(12) Patent Application Publication
(10) Pub. No.: US 2006/0215200 A1
(43) Pub. Date: Sep. 28, 2006

(54) Printing control system and method

(76) Inventors: Yasuo Mutsuro, Yokohama-shi (JP); Hiroki Mizosoe, Yokohama-shi (JP); Naoyuki Urata, Ebina-shi (JP); Nobuyuki Sato, Ebina-shi (JP); Shiro Kofuji, Ebina-shi (JP); Junichi Satoh, Ebina-shi (JP)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 11/369,982

(22) Filed: Mar. 8, 2006

(30) Foreign Application Priority Data
Mar. 11, 2005 (JP) P2005-068956

(51) Int. Cl. G06F 3/12

(52) U.S. Cl. 358/1.13; 358/448

(57) ABSTRACT

A printing control system includes a drawing unit, a block data generating unit and a controlling unit. The drawing unit sets a drawing region in which a region of an original image falls, and draws the original image in the drawing region so that a center of the region of the original image is in coincidence with a center of the drawing region. The block data generating unit divides the drawing region into a plurality of blocks, each block having a size and shape identical to one another, and generates block data representative of the plurality of blocks. The controlling unit performs an image processing on a block data basis to generate print data. The image processing includes a rotating processing for rotating each block.

### BACKGROUND OF THE INVENTION

1. Field of the Invention

The present invention relates to a system and method for controlling a printing operation, and particularly a printing operation in which print data is processed efficiently.

2. Description of the Related Art

Along with recent advances in high-resolution printing and color printing in recent years, the volume of print data required when printing images on office and home printers has increased dramatically. The increased volume of print data has necessitated an increase in the volume of data saved on the printer for image processing and, consequently, an increase in memory capacity in the printer. However, an increase in memory capacity leads to an increase in the cost of the printer. To resolve this problem, techniques have been proposed for processing print data efficiently using a small memory capacity.

A page printer disclosed in Japanese unexamined patent application publication No. 2003-296054 has a function for generating de-compressible compression data from image data transmitted by a host device. The host device sequentially transmits a page worth of image data in units of bands, while the page printer function divides the page worth of data into a matrix having a plurality of blocks of image data and generates compression data for each block. The page printer has another function for rotating the image data received from the host device 90 degrees when generating print data based on these blocks of compressed data. A page printer having this construction can thus generate print data that has been rotated 90 degrees without allocating a storage area for storing one page worth of print data, thereby reducing the required capacity of the memory in the page printer.

However, when dividing the image data (original image) into a matrix during this process, the original image is not always of a size that can be divided into an integral number of blocks of the block size. Accordingly, a technique was proposed for first adding a blank image data to the end of the original image so that the original image can be divided into an integral number of blocks prior to dividing the image into a matrix.

Japanese unexamined patent application publication No. 2004-128811 proposes a technique for outputting an image that has undergone rotation processing after adding blank image data thereto without losing any of the original image data when processing the image divisions. Specifically, an image-processing device described in Japanese unexamined patent application publication No. 2004-128811 has a function for dividing the original image of a first size, such as A4 size, into image divisions (tile images) of a prescribed size using first coordinates as a reference, and generating a set of image divisions that together form a second size; a function for rotating the set of image divisions with respect to a center point of the second size; and a function for outputting an output image corresponding to the original image using the first coordinates as a reference, based on the set of rotated image divisions. Here, the generating function ensures that the entire rotated original image is included in the output image by determining which of the image divisions includes a differential region (margin) between the first size and the second size based on details of the rotation process formed by the processing means. This technique can prevent the loss of image data when rotating the image 180 degrees, for example, by providing a margin on the left and upper sides of the original image.

While the technique in Japanese unexamined patent application publication No. 2003-296054 divides image data for one page into a plurality of block images, the original image is not always of a size that can be divided into an integral number of block images, as described above. Accordingly, this technique requires special processes for providing margins and the like.

Further, while the technique in Japanese unexamined patent application publication No. 2004-128811 divides the original image data after adding margins, it is necessary to determine appropriately to which parts of the original image margin portions need to be added so that image data is not lost in the outputted image. This must be determined based on the details of the rotation process, such as the angle of rotation (90 degrees, 180 degrees, 270 degrees, or the like) In other words, the rotation conditions must be determined each time an image is divided, leading to a more complex process. Alternatively, the position for printing each image division can be adjusted individually, but this operation is also complex.

Further, when the printer driver of the host computer generates the image divisions, it is necessary not only to rotate the image divisions according to whether the orientation is a landscape orientation or a portrait orientation, but also to rotate the page based on the direction in which the paper is loaded in the printer, for example, when printing on A4-size paper in an A3 printer. In such a case, the printer driver and printer must communicate in order to determine the orientation of the loaded paper. Moreover, extremely complex processing is required when the rotational direction differs according to the page and when printing a plurality of pages on one sheet of paper.

Further, when the printer is generating the image divisions, a longer processing time is required since the CPU in the printer generally has a lower processing capacity than that in the host computer. Providing a high-capacity CPU in the printer to increase processing speed would also increase costs.

### SUMMARY OF THE INVENTION

In view of the foregoing, it is an object of the present invention to provide a printing control system and a printing control method capable of suitably executing a printing operation and the like that includes rotation processes, without overly burdening the printer driver of the host computer and the printer controller.

In order to attain the above and other objects, the present invention provides a printing control system includes a drawing unit, a block data generating unit and a controlling unit. The drawing unit sets a drawing region in which a region of an original image falls, and draws the original image in the drawing region so that a center of the region of the original image is in coincidence with a center of the drawing region. The block data generating unit divides the drawing region into a plurality of blocks, each block having a size and shape identical to one another, and generates block data representative of the plurality of blocks. The controlling unit performs an image processing on a block data basis to generate print data. The image processing includes a rotating processing for rotating each block.

Another aspect of the present invention provides a printing control method includes steps (a)-(e). Step (a) sets a drawing region in which a region of an original image falls. Step (b) draws the original image in the drawing region so that a center of the region of the original image is in coincidence with a center of the drawing region. Step (c) divides the drawing region into a plurality of blocks, each block having a size and shape identical to one another Step (d) generates block data representative of the plurality of blocks. Step (e) performs an image processing on a block data basis to generate print data. The image processing includes a rotating processing for rotating each block.

### BRIEF DESCRIPTION OF THE DRAWINGS

The above and other objects, features and advantages of the invention will become more apparent from reading the following description of the preferred embodiments taken in connection with the accompanying drawings in which:

FIG. 1 is a block diagram showing a printing control system according to a first embodiment of the present invention;

FIG. 2 is a flowchart showing steps in a printing control method performed by the printing control system in FIG. 1;

FIGS. 3A through 3D are explanatory diagrams illustrating how a printed image is divided and rotated;

FIG. 4 is an explanatory diagram showing a sample of additional information generated by the block data generating device;

FIG. 5 is an explanatory diagram showing a sample list of block position data generated by the print controlling device;

FIG. 6 is an explanatory diagram illustrating a sample block data stored in the raster data block storing means;

FIG. 7 is an explanatory diagram illustrating a sample list of block position data according to a second embodiment of the present invention; and

FIG. 8 is a block diagram of a printing control system according to a third embodiment of the present invention.

### DETAILED DESCRIPTION OF THE PREFERRED EMBODIMENTS

A printing control system and a printing control method according to first embodiment of the present invention will be described while referring to the accompanying drawings wherein like parts and components are designated by the same reference numerals to avoid duplicating description.

In the following description, the expressions “front”, “rear”, “upper”, “lower”, “right”, and “left” are used to define the various parts when the printing control system is disposed in an orientation in which it is intended to be used.

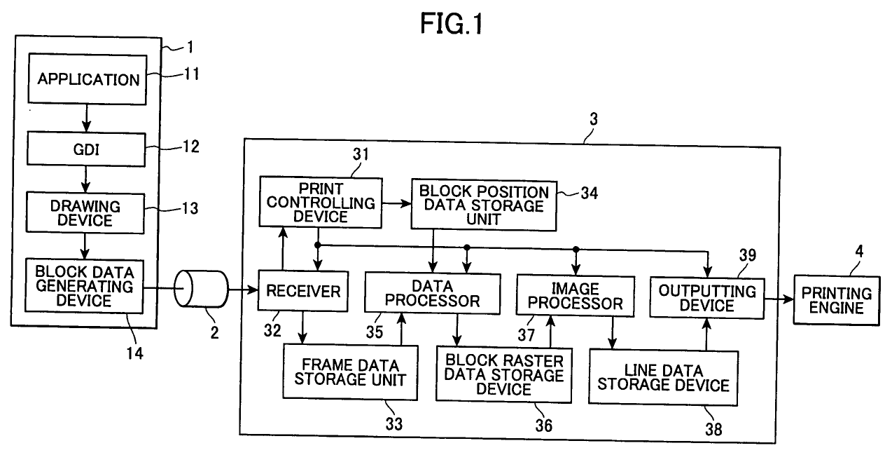

FIG. 1 is a block diagram showing a printing control system according to a first embodiment of the present invention. The printing control system shown in FIG. 1 includes a host computer 1 and a printer controller 3 that is connected to the host computer 1 via a communication path 2, such as a local area network (LAN) or a universal serial bus (USB).

The host computer 1 includes an application 11 with which the user can directly input a print command; a graphics device interface (GDI) 12, which is a graphical subsystem provided in an operating system; a drawing device 13, such as a printer driver; and a block data generating device 14 for generating block data by dividing an image to be printed (print data) into tiles of a prescribed size. The block data generating device 14 may also be incorporated as a function of the drawing device 13.

The printer controller 3 includes a print controlling device 31, a receiver 32, a frame data storage unit 33, a block position data storage device 34, a data processor 35, a raster data block storage device 36, an image processor 37, a line data storage device 38, and an outputting device 39. The printer controller 3 is also connected to a printing engine 4.

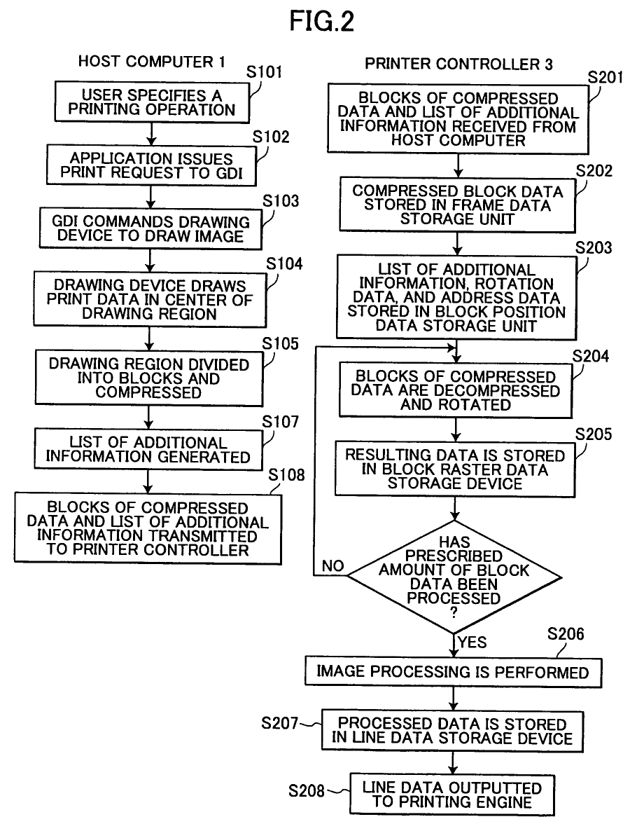

FIG. 2 is a flowchart showing a printing control method according to the preferred embodiment performed with the printing control system in FIG. 1. In S101, the user issues a print command with the application 11 executing on the host computer 1. In S102 the application 11 issues a print request to the GDI 12. In S103 the GDI 12 instructs the drawing device 13 to draw the print data.

In S104 the drawing device 13 draws the print data in a region, for example, on a virtual region in a memory (not shown) or a screen (not shown), which will hereinafter be referred to as the “drawing region,” so that the center of the region of the print data is substantially in coincidence with the center of the drawing region. The drawing region is larger than the region of the original image that is, for example A4 size, to be printed (print data) and is an integral multiple of the prescribed size for tile images produced by the block data generating device 14.

After the drawing device 13 draws the print data, in S105 the block data generating device 14 divides the drawing region for the print data into tile images and generates a block of data for each tile image. Each block is then compressed using a technique such as Modified Huffman (MH) coding. These processes help to reduce the amount of memory required for image processing.

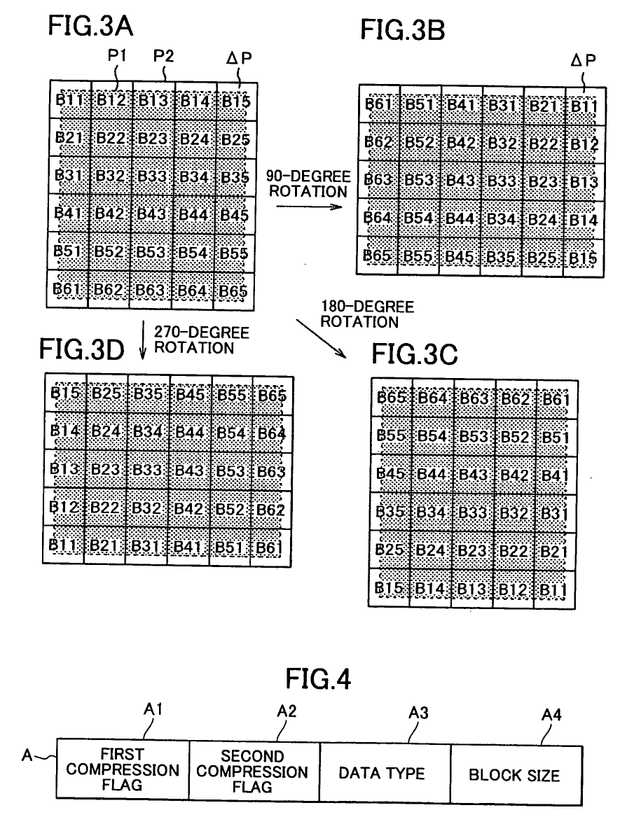

FIG. 3 is an explanatory diagram illustrating how the processes of image division and page rotation are executed for a printed image according to the preferred embodiment. FIG. 3(a) illustrates how the image is divided into tile images. P1 indicates the region occupied by the original image to be printed (print data). P2 indicates the drawing region that is of a size greater than or equal to the region P1 (P1<P2) and capable of accommodating an integral number of blocks (tile images) of a prescribed size (five blocks horizontally and six blocks vertically in the preferred embodiment). The center of the original image region P1 is substantially aligned with the center of the drawing region P2. Hence, a differential region ΔP indicating the region on the edges of the region P2 not occupied by the region P1 is uniform along the four edges of the peripheral region so as to be symmetrical both vertically and horizontally. B11-B65 indicate blocks of compressed data for the divided tile images.

FIGS. 3(b), 3(c), and 3(d) show the block layout of this compressed data as the original image is rotated clockwise 90 degrees, 180 degrees, and 270 degrees, respectively. When the image is rotated 90 degrees, as shown in FIG. 3(b), the block B61 positioned in the bottom left corner in FIG. 3(a) is now positioned in the top left corner. Since the rotation process is executed separately on each unit block, and each block is in a prescribed position, the blocks are rotated about the center of the drawing region P2. Since the center of the original image region P1 matches the center of the drawing region P2, the differential region ΔP remains uniform around the peripheral edges of the image after rotation. In other words, the printed image is not shifted out of position due to the rotation process. The position of the original image can be matched to the position of the printed image, particularly when the drawing region is square. Since the method of the preferred embodiment matches the center of the original image region to the center of the drawing region, shifting of the printed image can be eliminated in all rotation processes, and a special process need not be performed to accomplish this.

While the drawing device 13 draws the image so that the center of the original image region P1 is aligned with the center of the drawing region P2, there obviously must be some allowance for error in positioning due to the resolution of the image determined by the size of the printed dots and the like and, consequently, a slight shift in the images, but of a degree that does not affect printing quality.

Next, in S107, the block data generating device 14 generates additional information, such as the size of each block of compression data.

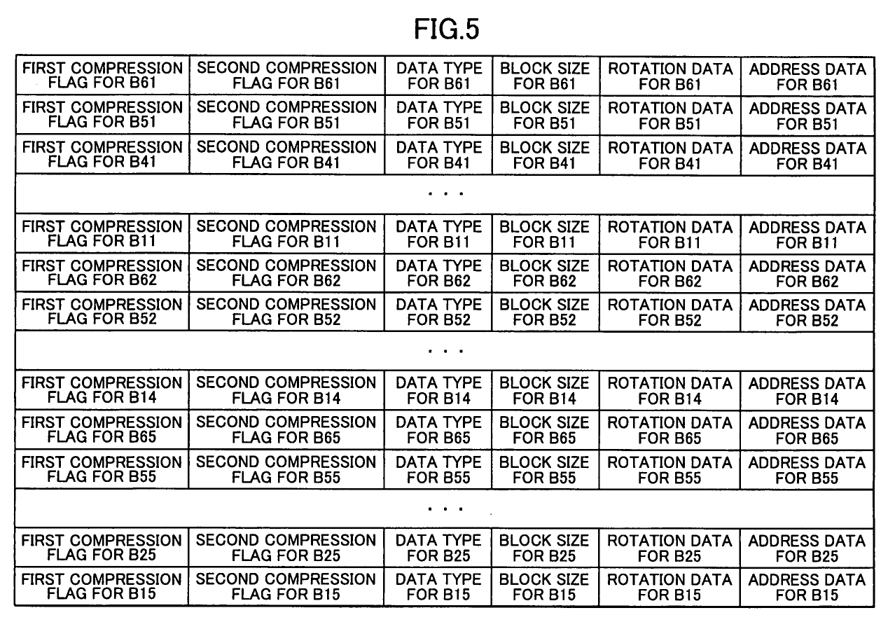

FIG. 4 shows an example of such additional information. Assuming the system supports two compression methods and two data types (binary data and multivalued data), the additional information enables the printer controller 3 to identify these conditions. In the example of FIG. 4, an additional information A includes a first compression flag A1 indicating whether the first compression method has been applied to the block data, a second compression flag A2 indicating whether a second compression method has been applied to the block data, a data type A3 specifying either binary data or multivalued data, and a block size A4 indicating the size of each block in bytes. The block size A4 is necessary for reading blocks of data stored in memory without reading too much or too little when using variable-length compression.

In S107 the block data generating device 14 generates data for a list of additional information in which the additional information A for all blocks is concatenated into a list. In S108 the host computer 1 transmits the list of additional information and the blocks of compression data to the printer controller 3 via the communication path 2.

In S201 the receiver 32 of the printer controller 3 receives the list of additional information and blocks of compressed data and notifies the print controlling device 31 of this reception. In S202 the print controlling device 31 commands the receiver 32 to transmit the received blocks of compressed data for storage in the frame data storage unit 33. The print controlling device 31 also receives the list of additional information from the receiver 32, as well as information on the orientation of paper mounted in a paper cassette that is managed by the printer controller 3. Based on this data, the print controlling device 31 creates a list of block position data in S203 and stores the results in the block position data storage device 34. The list of block position data is created by appending the rotation process data for each block of compressed data, and address data indicating where each block of compressed data is stored in the frame data storage unit 33 to the additional information for each respective block.

During this process, the print controlling device 31 calculates a new block layout for the compression data after page rotation and creates a list of block position data in an order for sequentially reading blocks of compressed data to process the data according to the new layout. Therefore, if rotation is required based on the loaded orientation of the paper in addition to rotation specified by the host computer, the printer controller 3 can readily perform a rotation process based on the rotation process data in this list.

FIG. 5 shows an example of a list of block position data. This example shows the case of FIG. 3(b) in which the page is rotated 90 degrees. As shown in FIG. 5, the list of block position data includes entries for a first compression flag, a second compression flag, a data type, a block size, rotation data, and address data. The block position data is listed in a sequence for scanning data in order that image processing can be performed based on the block layout after page rotation. Specifically, the block B61 in the upper left corner of the page shown in FIG. 3(b) is set as the starting point, and subsequent entries are list in the order B51, B41, . . . . After listing entries through B11 on the right edge of the image, the list continues from the entry for block B62 on the left edge in the next row of blocks and progresses again to the right. By repeating this process, entries are listed through block B15 in the bottom right corner of the page. Further, the rotation data for each block indicates a 90-degree rotation process in this example.

The frame data storage unit 33 stores blocks of compressed data for at least one page worth. After at least one page worth of compressed data has been stored in the frame data storage unit 33, the data processor 35 is commanded by the print controlling device 31 to read each block of compressed data from the frame data storage unit 33 based on the list of block positioning data stored in the block position data storage device 34. In S204 the data processor 35 performs processes for decompressing and rotating the blocks of compressed data read from the data processor 35. In S205 the data processor 35 stores the processed data in the raster data block storage device 36.

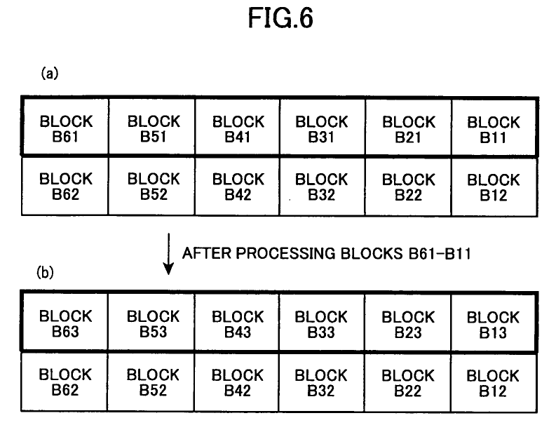

FIG. 6 shows a conceptual view of block data stored in the raster data block storage device 36. After a page of block data has been processed, the block data is stored in the raster data block storage device 36 in blocks of raster data. FIG. 6 (a) shows an example of two blocks worth of raster data (B61-B11 and B62-B12) stored in the raster data block storage device 36.

After a prescribed amount of block data (such as one block worth of raster data) has been stored in the raster data block storage device 36, the print controlling device 31 commands the image processor 37 in S206 to read block data required for image processing and to perform image processing, such as gamma correction, UCR/BG (under color removal/black generation), and smoothing.

These processes are performed in parallel with the storage operation. Hence, after the image processor 37 has completed processing the blocks B61-B11 and shifts to the next block of raster data including blocks B62-B12, the data processor 35 begins reading the next blocks B63-B13 from the frame data storage unit 33 as shown in FIG. 6 (b), decompresses the block data, performs rotation processes thereon, and transmits the resulting data to the raster data block storage device 36. Since the print data has been divided into tiles, block data can be developed in the raster data block storage device 36 based on the rotated direction of the page, and developed block data can be outputted to the printing engine 4 in a parallel operation, thereby eliminating the need for a raster data block storage device with a one page capacity and reducing the required memory capacity.

In S207 data processed by the image processor 37 is stored in the line data storage device 38. The line data storage device 38 saves print data that the print engine can process directly. Once a fixed amount of line data, such as eight lines worth of data, has been stored in the line data storage device 38, the print controlling device 31 commands the outputting device 39 to transmit this line data to the printing engine 4. In S208 the outputting device 39 reads the line data from the line data storage device 38 and transmits the line data to the printing engine 4.

Here, the line data saved in the line data storage device 38 is data for the size of the drawing region P2 shown in FIG. 3. Since line data for the differential region ΔP between the drawing region P2 and the original image region P1 is unnecessary, the above control operation prevents this line data from being outputted. Specifically, when reading block data for image processing from the raster data block storage device 36, for example, the image processor 37 skips over the unnecessary block data. The amount of data to skip, that is, the size of the differential region ΔP can be easily calculated from the drawing region P2 and original image region P1. Alternatively, line data for the differential region ΔP may be outputted as is, and the printing engine 4 may be configured to control the printing operation based on a print control signal (flag) attached to the data. After receiving the line data, the printing engine 4 prints an image on paper based on the data.

With the printing control system and printing control method of the preferred embodiment described above, a large load is not placed on the printer driver of the host computer 1 nor on the printer controller 3. Further, a printing process including rotation processes can be reliably executed without shifting the printed image. Hence, it is possible to conserve memory capacity and to achieve high processing speeds since no special processes are required.

Further, when printing a plurality of pages including rotated pages condensed and arranged on a single sheet of paper, the print data is drawn in the center of a drawing region configured of tile-like block data. Accordingly, no positional deviation occurs among the plurality of pages condensed on the same printing surface.

While the block data generating device 14 compresses all block data in the preferred embodiment, the block data generating device 14 may also be configured to selectively compress block data. In this case, it is possible to notify the printer controller 3 by indicating whether compression exists using the first compression flag A1 or second compression flag A2 in the additional information A of FIG. 4. Further, while the block data generating device 14 performs two types of compression in the first embodiment described above, one type or three or more types of compression may be used, provided that compression flags equivalent to the number of compression methods are provided in the additional information A.

Further, while the data processor 35 rotates the block data in the preferred embodiment, the image processor 37 may be configured to perform this rotation instead. In this case, the image processor 37 performs the rotation after reading rotation data for each block data from the block position data storage device 34 or after receiving the rotation data for each block data from the data processor 35.

Next, a second embodiment of the printing control system and printing control method according to the present invention will be described. The second embodiment differs from the first embodiment in that the block data generating device 14 does not generate the additional information A in a list, but appends the additional information A to the head of each block of compressed data and transmits the blocks of compressed data to the printer controller 3. Accordingly, the print controlling device 31 may generate a simplified list of block position data (rotation data and address data) and may store this list in the block position data storage device 34.

Here, a printing operation performed on the printing control system according to the second embodiment will be described. As in the operation according to the first embodiment, an original image is divided into tile images and blocks of compressed data are generated from the tile images. The block data generating device 14 appends the additional information A of each block to the head of the respective block of compressed data. Here, the additional information A in the second embodiment has the same structure as that shown in FIG. 4. Thus, the block of compressed data is added after the block size A4 at the end of the additional information A. Note that a position at which the additional information A is added may not be the head of the respective block of compressed data.

Upon receiving the blocks of compressed data, the print controlling device 31 extracts the additional information A, creates a list of block position data based on the additional information A, and stores the list in the block position data storage device 34. In the second embodiment, the list of block position data includes rotation data for each block of compressed data and address data indicating where the blocks are stored in the frame data storage unit 33, but omits data indicating the method of compression and the like included in the additional information A.

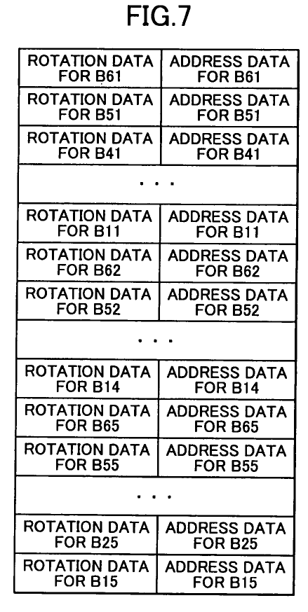

FIG. 7 shows a sample list of block position data according to the second embodiment when a 90-degree page rotation is being performed. Each entry in the list of block position data is configured of rotation data and address data for each block of data. Further, the entries of block position data are listed in a sequence for scanning data in order that image processing can be performed based on the block layout after page rotation.

The data processor 35 reads data according to the additional information A appended to each block of compressed data and the data described in the list of block position data, performs decompression and rotation processes on this data, and transmits the result to the raster data block storage device 36. The remaining steps of this process are the same as described in the first embodiment.

The second embodiment not only obtains the same effects as those described in the first embodiment, but can also reduce the volume of block position data stored in the block position data storage device 34. Accordingly, the second embodiment reduces the memory capacity required for this process, enabling the data processor 35 to execute the process more efficiently.

Next, a third embodiment of the printing control system and printing control method according to the present invention will be described.

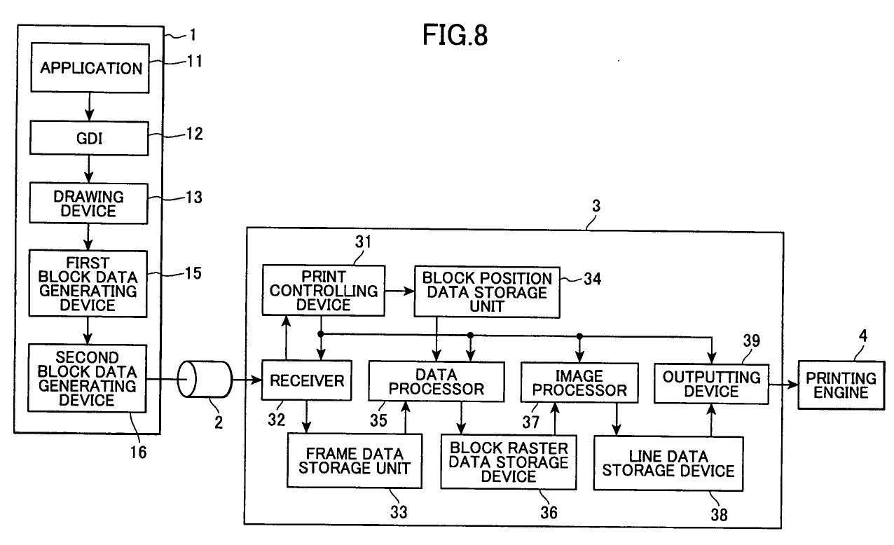

FIG. 8 is a block diagram showing the structure of a printing control system according to the third embodiment. The host computer 1 according to the third embodiment differs from the first embodiment in that the block data generating device 14 is divided into two stages including a first block data generating device 15 and a second block data generating device 16. The first block data generating device 15 functions to compress a plurality of pixels into a single block using fixed-length compression, such as BTC (block truncation coding). The second block data generating device 16 further combines a plurality of blocks of data generated by the first block data generating device 15 to produce macro blocks of data.

Next, a printing operation performed by the printing control system according to the third embodiment will be described. First, the drawing device 13 of the host computer 1 performs drawing in the drawing region, as described in the first embodiment. The first block data generating device 15 then forms blocks in the drawing region, with the original image centered in the drawing region, using BTC or a similar compression technique, and generates blocks of data. Subsequently, the second block data generating device 16 produces macro blocks of data by combining a plurality of blocks generated by the first block data generating device 15 and compresses each macro block using MH coding or a similar technique to produce macro blocks of compressed data. In this example, each of the first blocks produced by the first block data generating device 15 are 8×8 dots in size, while the second macro blocks produced by the second block data generating device 16 are 8×8 blocks in size (in other words, 64×64 dots in size).

The second block data generating device 16 also generates additional information including the size of the compressed macro blocks, for example. The content of the additional information is identical to that in the first embodiment. The second block data generating device 16 then concatenates the additional information A for each of the compressed macro blocks in a list form and generates data for the list of additional information. The second block data generating device 16 transmits data for the list of additional information and the compressed macro blocks to the printer controller 3 via the communication path 2.

The printer controller 3 basically performs the same operations described in the first embodiment. However, since the image data is processed in units of macro blocks in the third embodiment, the data processor 35 must employ a decompressing process that decompresses both the second blocks and the first blocks.

The printing control system according to the third embodiment not only obtains the same effects as those described in the first embodiment, but can also generate compression data more efficiently by generating blocks of image data in a plurality of stages. Hence, the host computer 1 according to the third embodiment contributes to a reduced volume of data being exchanged and a lower required capacity of memory.

While the preferred embodiments described above are representative examples, a combination of these embodiments may also be employed.

For example, the methods in the second and third embodiments may be combined to generate blocks of data in a plurality of stages (macro blocks), to append additional information for each block to the head of the macro blocks of compressed data, and to subsequently transmit the compressed macro blocks to the printer controller 3. The present invention may also be employed to partially modify functions of a processing means constituting a system.

Though the drawing region is larger than the region of the original image in the above-described embodiments, the drawing region is smaller than the region of the original image. In such a case, if there are images only at a center of the original image, it produces an identical effect as the above-described embodiments.

What is claimed is:

1. A printing control system comprising:
a drawing unit that sets a drawing region in which a region of an original image falls, and draws the original image in the drawing region so that a center of the region of the original image is in coincidence with a center of the drawing region;
a block data generating unit that divides the drawing region into a plurality of blocks, each block having a size and shape identical to one another, and generates block data representative of the plurality of blocks; and
a controlling unit that performs an image processing on a block data basis to generate print data, the image processing including a rotating processing for rotating each block.

2. The printing control system according to claim 1, wherein the drawing unit sets the drawing region so that distances between a periphery of the drawing region and a periphery of the region of the original image are uniform.

3. The printing control system according to claim 1, wherein the controlling unit comprises a list generating unit that generates a block data list including rotational data for rotating the block,
wherein the controlling unit performs the image processing based on the block data list.

4. The printing control system according to claim 1, wherein the block data generating unit comprises a compressing unit that compresses the block data to generate compressed block data;
wherein the controlling unit comprises:
a data processing unit that decompresses the compressed block data to generate the decompressed data; and
a first storing unit that stores the decompressed block data;
wherein the controlling unit outputs the decompressed block data that has been stored in the first storing unit to a printing unit before subsequently generated decompressed block data is stored in the first storing unit.

5. The printing control system according to claim 4, wherein the controlling unit comprises:
a second storing unit that stores the compressed block data; and
a list generating unit that generates a block data list including an address in the second storing unit of each compressed block data,
wherein the image processing unit performs the image processing based on the block data list.

6. The printing control system according to claim 4, further comprising a list generating unit that generates a block data list including information on compression for the block data,
wherein the block data generating unit generates additional information for each compressed block data.

7. The printing control system according to claim 6, wherein the block data generating unit combines the additional information with the compressed block data.
wherein the controlling unit performs the image processing based on the block data list.

8. The printing control system according to claim 1, wherein the controlling unit outputs only the print data including the block data corresponding to the original image to a printing unit.

9. The printing control system according to claim 1, wherein the image processing includes a line data processing for arranging the rotated blocks to generate line data.

10. The printing control system according to claim 9, wherein the controlling unit outputs only the line data including the block data corresponding to the original image to a printing unit.

11. The printing control system according to claim 1, wherein the block data generating unit compresses the block data to generate compressed block data, organizes the plurality of compressed block data to generate macro block data, and compresses the macro block data to generate compressed macro block data,
wherein the controlling unit decompresses the compressed macro block data to generate the decompressed data.

12. A printing control method comprising:
step (a) setting a drawing region in which a region of an original image falls;
step (b) drawing the original image in the drawing region so that a center of the region of the original image is in coincidence with a center of the drawing region;
step (c) dividing the drawing region into a plurality of blocks, each block having a size and shape identical to one another;
step (d) generating block data representative of the plurality of blocks; and
step (e) performing an image processing on a block data basis to generate print data, the image processing including a rotating processing for rotating each block.

13. The printing control method according to claim 12, wherein step (a) comprises step (a1) setting the drawing region so that distances between a periphery of the drawing region and a periphery of the region of the original image are uniform.

14. The printing control method according to claim 12, further comprising step (f) generating a block data list including rotational data for rotating the block data,
wherein step (e) comprises step (e1) performing the image processing based on the block data list.

15. The printing control method according to claim 12, wherein step (d) comprises step (d1) compressing the block data to generate compressed block data;
wherein step (e) comprises:
step (e2) decompressing the compressed block data to generate decompressed block data
step (e3) storing the decompressed block data in a first storing unit;
step (e4) outputting the decompressed block data that has been stored in the first storing unit to a printing unit before subsequently generated decompressed block data is stored in the first storing unit.

16. The printing control method according to claim 15, wherein step (e) comprises:
step (e5) storing the compressed block data in a second storing unit;
step (e6) generating a block data list including an address in the second storing unit of each compressed block data; and
step (e7) performing the image processing based on the block data list.

17. The printing control method according to claim 15, further comprising step (g) generating a block data list including information on compression for the block data,
wherein step (d) comprises step (d2) generating additional information for each compressed block data.

18. The printing control method according to claim 17, wherein step (d) comprises step (d3) combining the additional information with the compressed block data.

19. The printing control method according to claim 12, wherein step (e) comprises step (e8) outputting only the print data including the block data corresponding to the original image to a printing unit.

20. The printing control method according to claim 12, wherein the image processing includes a line data processing for arranging the rotated blocks to generate line data.

21. The printing control method according to claim 20, wherein step (e) comprises step (e9) outputting only the line data including the block data corresponding to the original image to a printing unit.

22. The printing control method according to claim 12, wherein step (d) comprises:
step (d4) compressing the block data to generate compressed block data;
step (d5) organizing the plurality of compressed block data to generate macro block data; and
step (d6) compressing the macro block data to generate compressed macro block data,
wherein step (e) comprises step (e10) decompressing the compressed macro block data to generate the decompressed data.
